(19) United States
(12) Patent Application Publication
(10) Pub. No.: US 2026/0146170 A1
(43) Pub. Date: May 28, 2026

(54) THREE-DIMENSIONALLY PRINTED PARTS AND SECOND-GENERATION PRODUCTS FORMED THEREFROM

(71) Applicant: PERIDOT PRINT LLC, Palo Alto, CA (US)

(72) Inventors: Jake H. Thomas, San Diego, CA (US); Emre Hiro Discekici, San Diego, CA (US); Emily Levin, San Diego, CA (US); Alay Yemane, San Diego, CA (US)

(21) Appl. No.: 19/095,579

(22) Filed: Mar. 31, 2025

Related U.S. Application Data
(60) Provisional application No. 63/724,819, filed on Nov. 25, 2024.

(51) Int. Cl. C09D 7/41; B29B 17/02; B29C 64/165; B29K 77/00; B29K 105/00; B33Y 70/00; C08K 5/00; C09D 7/20; C09D 7/45; C09D 7/63; C09D 177/00

(52) U.S. Cl. CPC C09D 7/41; B29B 17/02; B33Y 70/00; C09D 7/20; C09D 7/45; C09D 7/63; C09D 177/00; B29C 64/165; B29K 2077/00; B29K 2105/0032; C08K 5/0041

(57) ABSTRACT

Three-dimensionally printed parts are exposed to different processes enabling the parts or components thereof to be reused. In one example, a 3D printed part is exposed to an absorber extraction process, and the absorber extracted from the 3D printed part is used to form a second-generation fusing agent. In another example, a 3D printed part is divided into smaller pieces and injection molded to form a second-generation 3D object with unexpectedly high mechanical properties.

### CROSS-REFERENCE TO RELATED APPLICATION

This application claims the benefit of U.S. Provisional Application Ser. No. 63/724,819, filed Nov. 25, 2024, the contents of which is incorporated by reference herein in its entirety.

### BACKGROUND

A three-dimensional (3D) printing process is a form of additive manufacturing that can be used to form 3D solid parts, e.g., using a digital model. Some additive 3D printing techniques involve the iterative application of successive layers of materials, such as build material composition(s), fusing agent(s), and the like. In some of these additive 3D printing techniques, at least partial curing, thermal merging/fusing, melting, sintering, etc. of the build material composition(s) may be used to form 3D solid parts, and the mechanism for material coalescence may depend upon the type of build material composition(s) used. For some materials, at least partial melting may be accomplished using heat-assisted extrusion, and for some other materials, curing or fusing may be accomplished using photonic energy sources, such as ultra-violet light or infrared light.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Features of examples of the present disclosure will become apparent by reference to the following detailed description and drawings.

FIG. 1 is a photograph of a colored, thermoplastic polyamide object, in the shape of a shoe sole, that was 3D printed using a fusing agent including Acid Yellow (AY) 23 dye.

FIG. 2 is a photograph of the top of a container including pieces of two shoe soles (including that shown in FIG. 1) submerged in an aqueous solution for absorber (e.g., dye) extraction.

FIG. 3 is a photograph of the top of a container including an absorber extract solution obtained from the extraction process shown in FIG. 2, after the absorber extract solution was exposed to filtration.

FIG. 4 is a graph depicting the absorbance spectrum, in terms of optical absorbance (arbitrary units, Y axis) vs. wavelength (nm, X axis), of the absorber extract solution including the AY 23 dye extracted from the thermoplastic polyamide object and of a second-generation fusing agent formed from the absorber extract solution.

FIG. 5 is a photograph of a print formed by two-dimensional (2D) printing of the second-generation fusing agent formed from the absorber extract solution including the extracted AY 23 dye.

FIG. 6 is a photograph of thermoplastic polyamide objects, in the shape shoe sole keychains, that were 3D printed using the second-generation fusing agent formed from the absorber extract solution including the extracted AY 23 dye.

FIG. 7 is a graph depicting tensile strength (MPa, top Y axis) and Elongation @ Break (bottom Y axis) for neat, control, and example injection molded parts. The Mean of the two values is also depicted.

### DETAILED DESCRIPTION

Some 3D printing methods or techniques utilize a layer-by-layer process to build up the 3D solid part. For each layer, a fusing agent containing an energy absorbing substance (e.g., an energy absorber) is used to pattern a build material composition, thereby forming a patterned region. In these methods or techniques, the entire layer of the build material composition is exposed to radiation, and the patterned region is coalesced and becomes a layer of a 3D solid part (or 3D printed object). In the patterned region, the energy absorbing substance is capable of at least partially penetrating into voids between the particles of the build material composition and is also capable of spreading onto an exterior surface of particles within the build material composition. The energy absorbing substance is also capable of converting absorbed radiation energy into thermal energy, which may be used to coalesce build material particles that have been patterned with the fusing agent, and energy absorbing substance. As used herein, “coalescence” refers to a process where individual droplets and/or particles of material merge together to form a continuous, solid structure. In this context, coalescing causes the build material particles to join or blend to form a single entity (i.e., a layer of the 3D solid part). Coalescing may involve at least partial thermal merging, melting, binding, and/or some other mechanism that causes the build material composition to form the layer of the 3D solid part.

As mentioned, the fusing agent is used to deliver the energy absorber to the build material composition. Some fusing agents include carbon black as the energy absorber because it is a highly efficient infrared energy absorber. However, carbon black containing fusing agents result in strongly colored 3D solid parts. The carbon black becomes embedded into the matrix of the coalesced build material, resulting in black- or grey-colored 3D solid parts. The embedded carbon black may pose challenges when attempting to recycle the black- or grey-colored 3D solid parts because the embedded pigment can adversely affect the color and/or mechanical properties of whatever is made from the recycled black- or grey-colored 3D solid parts. Additionally, extraction of carbon black from the black- or grey-colored 3D solid parts involves time-consuming, energy intensive, and difficult-to-scale processes, such as ultracentrifugation.

The examples set forth herein provide methods for reusing 3D solid parts or dyes extracted therefrom to form second-generation products. Each of the methods begins with an initial 3D printed solid part that had been formed using a dye-based fusing agent or a colorless ultraviolet (UV) radiation energy absorber-based fusing agent.

In one example method, a dye or colorless UV radiation absorber is extracted from the initial 3D printed solid part, and is mixed with a liquid vehicle to form a second-generation fusing agent. This second-generation fusing agent is used in another 3D printing process to form a new 3D printed solid part. Removal of the dye or colorless UV radiation absorber from the previous part is achieved by exposing fragments of the previous part to a solution of water and ethanol for an amount of time sufficient to extract or leech the dye or colorless UV radiation absorber from the fragments. It has been found that the extracted/leeched dye or colorless UV radiation absorber can be concentrated down by evaporation, and efficiently reused as an energy absorber. In particular, the concentrated form of the extracted dye or colorless UV radiation absorber is combined with solvent(s) to form an absorber extract solution, and the absorber extract solution is used to form the second-generation fusing agent for subsequent 3D printing.

In another example method, the initial 3D printed solid part is divided into pieces and injection molded to form a second-generation solid part. As illustrated in the Examples set forth herein, these second-generation solid parts exhibited unexpectedly high mechanical properties.

The approaches described throughout the present disclosure provide both cost-effective and efficient methods for recycling and/or repurposing 3D printed solid parts.

Throughout this disclosure, a weight percentage that is referred to as “wt % active” refers to the weight percentage of the active component in a formulation. This is calculated by taking the mass of the active component and dividing it by the total mass of the formulation, then multiplying by 100 to get a percentage. Essentially, it represents the concentration of the active ingredient in the formulation, excluding any other non-active components present in the formulation. As an illustration, an energy absorber, such as a dye, may be present in a water-based formulation (e.g., a stock solution or dispersion) before being incorporated into a first-generation fusing agent. In this example, the wt % active of the energy absorber accounts for the loading (as a weight percent) of the energy absorber that is present in the first-generation fusing agent, and does not account for the weight of the other components (e.g., water, etc.).

Additionally, throughout this disclosure, the terms “3D printed solid part,” “3D solid part,” “3D printed part,” “3D printed object,” “3D part,” and “3D object” are used interchangeably herein.

### First-Generation Fusing Agent

Throughout this disclosure, the “first-generation fusing agent” refers to the fusing agent used to form an initial 3D printed part that is subsequently exposed to an absorber extraction process or to injection molding to form a new part.

The first-generation fusing agent of the present disclosure includes an energy absorber selected from the group consisting of a visible-light absorbing dye, an ultraviolet-light absorbing dye, or a colorless ultraviolet light absorber, a plasticizing solvent package, and water. In an example, the first-generation fusing agent consists of the listed components. In another example, the first-generation fusing agent includes the listed components, along with additive(s) as described herein.

As mentioned, the energy absorber is selected from the group consisting of a visible-light absorbing dye, an ultraviolet-light absorbing dye, or a colorless ultraviolet light absorber. The visible-light absorbing dye or ultraviolet-light absorbing dye imparts a non-black or non-grey color to the first-generation fusing agent, and thus to the initial 3D printed part. The colorless ultraviolet light absorber imparts no color to the first-generation fusing agent, and thus imparts no color to the initial 3D printed part.

In some examples, the energy absorber is a visible light absorbing dye. In an example, the energy absorber is a single visible light absorbing dye. In another example, the energy absorber is a combination of two or more visible light absorbing dyes. Such dye(s) are capable of absorbing electromagnetic energy at visible light wavelengths, and so the dye(s) function as an energy absorber in the first-generation fusing agent. Suitable visible light absorbing dyes include any organic or inorganic dye that is capable of absorbing light within the visible spectrum. In an example, the dye(s) have substantial absorption at wavelengths ranging from about 380 nm to about 700 nm. In another example, the dye(s) have substantial absorption at wavelengths ranging from about 400 nm to about 590 nm. As used herein, the term “substantial absorption” means that at least 80% of radiation having wavelengths within the specified range is absorbed by the substance being referred to. The dye(s) is capable of absorbing and converting absorbed visible light radiation into a sufficient amount of thermal energy to coalesce build material particles that have been patterned with the first-generation fusing agent (as will be described in more detail with reference to a 3D printing method below). Examples of visible light absorbing dyes that can be used include Direct Black (DB) 168, Acid Yellow (AY) 23, AY 17, Acid Red (AR) 52, AR 289, Reactive Red 180 (RR 180), Direct Blue (DB) 199, and combinations thereof. In one particular example, the visible light absorbing dye is AY 23.

In other examples, the energy absorber is a UV light absorbing dye. In an example, the energy absorber is a single UV light absorbing dye. In another example, the energy absorber is a combination of two or more UV light absorbing dyes. Such dye(s) are capable of absorbing electromagnetic energy at ultraviolet light wavelengths, and so the dye(s) function as an energy absorber in the first-generation fusing agent. Suitable UV light absorbing dyes include any organic or inorganic dye that is capable of absorbing light within the UV light spectrum. In an example, the dye(s) have substantial absorption at wavelengths ranging from about 10 nm to about 400 nm. The UV light absorbing dye(s) is capable of absorbing and converting absorbed ultraviolet light radiation into a sufficient amount of thermal energy to coalesce build material particles that have been patterned with the first-generation fusing agent. Examples of UV light absorbing dyes that can be used include pyranine, a pyranine derivative, coumarin, a coumarin derivative, a naphthalimide, a naphthalimide derivative, a disazomethine derivative, aldazine, and mixtures thereof. Specific examples of suitable UV light absorbing dyes include Solvent Green (SG) 7, AY 184, AY 250, Yellow 101, Basic Yellow (BY) 40, Solvent Yellow (SY) 43, SY 44, SY 85, SY 145, SY 160:1, and combinations thereof.

In an alternative example, the energy absorber is a colorless UV light absorber. Colorless UV light absorbers are chemical compounds that are capable of absorbing light within the UV light spectrum (i.e., from about 10 nm to about 400 nm) without appearing colored to the human eye. Examples of colorless UV light absorbers that can be used for the energy absorber in the first-generation fusing agent include benzotriazolyl dodecyl p-cresol, avobenzone, and diethylamino hydroxybenzoyl hexyl benzoate (DHHB).

In an example, the total amount of any of the dye(s) and/or colorless UV light absorber(s) present in the first-generation fusing agent ranges from about 0.01 wt % active to about 0.35 wt % active, based on the total weight of the first-generation fusing agent. In another example, the total amount of the dye(s) and/or colorless UV light absorber(s) present in the first-generation fusing agent ranges from about 0.1 wt % active to about 0.25 wt % active, based on the total weight of the first-generation fusing agent. The relatively low amount of the dye(s) and/or colorless UV light absorber(s) present in the first-generation fusing agent is due, at least in part, to the presence of the plasticizing solvent package described herein.

The first-generation fusing agent further includes the plasticizing solvent package. As used herein, the term “plasticizing solvent package” refers to co-solvent(s) other than water that is/are present in any example of the fusing agent set forth herein, where the “plasticizing solvent package” includes at least one plasticizing solvent. In some instances, all of the co-solvents of the plasticizing solvent package are plasticizing solvents. The plasticizing solvents can be combined together to form the plasticizing solvent package prior to being combined or mixed with other component(s) of the fusing agent (e.g., water, energy absorber, etc.). This may be useful when an aromatic alcohol is included in the solvent package as the other solvent in the package aids in bringing the aromatic alcohol into solution as described below. Alternatively, each of the plasticizing solvents could be incorporated into the fusing agent separately. The term “plasticizing solvent” refers to a low-volatile solvent that interacts with and increases the flexibility of (i.e., plasticizes) the build material polymer. This may generate a more pliable surface that improves energy absorber penetration. The plasticizing solvent(s) also facilitates a melt temperature reduction of the build material polymer. This enables a lower concentration of the energy absorber to be used without compromising the fusing efficiency.

In one example, the plasticizing solvent package consists of propylene glycol (PG or 1,2-propanediol). In this example, the plasticizing solvent package consists of a single plasticizing solvent (i.e., propylene glycol) and is free or devoid of any other solvents, including any other additional plasticizing solvent. The propylene glycol is present in the first-generation fusing agent in an amount ranging from about 40 wt % active to about 60 wt % active, based on the total weight of the first-generation fusing agent. In another example, the propylene glycol is present in the first-generation fusing agent in an amount ranging from about 45 wt % active to about 55 wt % active, based on the total weight of the fusing agent. In still another example, the propylene glycol is present in the first-generation fusing agent in an amount ranging from about 48 wt % active to about 52 wt % active, based on the total weight of the fusing agent. In a particular example, the propylene glycol is present in the first-generation fusing agent in an amount of about 50 wt % active.

In an alternative example, the plasticizing solvent package consists of an aromatic alcohol and a plasticizing solvent that increases the water solubility of the aromatic alcohol. The aromatic alcohol can be benzyl alcohol (which has the formula C₆H₅CH₂OH) or 2-phenoxyethanol. The aromatic alcohol is present in the first-generation fusing agent in an amount ranging from about 1 wt % active to about 20 wt % active, based on the total weight of the first-generation fusing agent. In another example, the aromatic alcohol is present in the first-generation fusing agent in an amount ranging from about 5 wt % active to about 15 wt % active, based on the total weight of the first-generation fusing agent. In still another example, the aromatic alcohol is present in the first-generation fusing agent in an amount ranging from about 8 wt % active to about 12 wt % active, based on the total weight of the first-generation fusing agent.

The plasticizing solvent in this example is any plasticizing solvent that is a solvent for the aromatic alcohol, and thus will suitably increase the water solubility of the aromatic alcohol. The solvent that is selected may have a higher solubility for the aromatic alcohol than water. In other words, the plasticizing solvent assists in bringing the aromatic alcohol into solution. The inclusion of such a solvent enables the fusing agent to be prepared with a predetermined amount of aromatic alcohol that is suitable for solubilizing and plasticizing the build material during 3D printing.

Plasticizing solvents that are solvents for some aromatic alcohols, such as benzyl alcohol, include water-soluble or water-miscible co-solvents, such as 2-pyrrolidone, 1-(2-hydroxyethyl)-2-pyrrolidone (HE2P), glycerol, isopropylidene glycerol (IPG), 2-methyl-1,3-propanediol, 1,2-butane diol, diethylene glycol, triethylene glycol, tetraethylene glycol, dipropylene glycol, diethylene glycol butyl ether, other glycol ethers, poly(ethylene glycol) 300, and combinations thereof. In an example, the plasticizing solvent is selected from the group consisting of 1-(2-hydroxyethyl)-2-pyrrolidone (HE2P), isopropylidene glycerol (IPG), polyethylene glycol (PEG) 300, and glycerol. In a particular example, the plasticizing solvent is 1-(2-hydroxyethyl)-2-pyrrolidone.

The amount of solvent for the aromatic alcohol that is included may depend, in part, upon the amount of aromatic alcohol that is included in the fusing agent. In an example, the benzyl alcohol and the solvent are present (in the fusing agent) in a weight ratio ranging from about 1:50 to about 2:3. In an example, the benzyl alcohol and the solvent are present in a weight ratio of 1:3.

The plasticizing solvent for the aromatic alcohol (e.g., benzyl alcohol) in the current example of the plasticizing solvent package may be present in the first-generation fusing agent in an amount ranging from about 5 wt % active to about 50 wt % active, based on the total weight of the first-generation fusing agent. In another example, the plasticizing solvent in the current example of the plasticizing solvent package is present in the first-generation fusing agent in an amount ranging from about 35 wt % active to about 45 wt % active, based on the total weight of the first-generation fusing agent.

In one specific example, the solvent package consists of the aromatic alcohol and the plasticizing solvent; the aromatic alcohol is selected from the group consisting of benzyl alcohol and 2-phenoxyethanol; and the plasticizing solvent is selected from the group consisting of 1-(2-hydroxyethyl)-2-pyrrolidone (HE2P), isopropylidene glycerol (IPG), poly(ethylene glycol) 300, and glycerol.

In another alternative example, the plasticizing solvent package consists of propylene glycol, an aromatic alcohol, and the plasticizing solvent. Aromatic alcohols and plasticizing solvents that may suitably be used for this example of the plasticizing solvent package are the same as described in the alternate example of the solvent package above. In one specific example, the solvent package consists of propylene glycol, the aromatic alcohol, and the plasticizing solvent; the aromatic alcohol is selected from the group consisting of benzyl alcohol and 2-phenoxyethanol; and the plasticizing solvent is selected from the group consisting of urea, 1-(2-hydroxyethyl)-2-pyrrolidone (HE2P), isopropylidene glycerol (IPG), poly(ethylene glycol) 300, and glycerol.

In this example of the plasticizing solvent package, the propylene glycol is present in an amount ranging from about 10 wt % active to about 35 wt % active, or from about 15 wt % active to about 25 wt % active, or from about 18 wt % active to about 32 wt % active, based on the total weight of the first-generation fusing agent. The aromatic alcohol is present in the fusing agent in an amount ranging from about 1 wt % active to about 20 wt % active, or from about 10 wt % active to about 20 wt % active, or from about 12 wt % active to about 16 wt % active, based on the total weight of the first-generation fusing agent. The plasticizing solvent is present in the fusing agent in an amount ranging from about 1 wt % active to about 50 wt % active, or 10 wt % active to about 20 wt % active, based on the total weight of the first-generation fusing agent. It is to be understood that the maximum total amount of the solvent(s) present in the first-generation fusing agent is 75 wt % active. In other words, the total amount of the solvent or solvents present in the first-generation fusing agent cannot exceed 75 wt % active.

In still another example, the plasticizing solvent package includes a first solvent selected from the group consisting of 2-pyrrolidone, dimethyl sulfoxide, methyl 4-hydroxybenzoate, dioctyl phthalate, N-methyl-2-pyrrolidone, N-2-hydroxyethyl-2-pyrrolidone, urea, ethylene carbonate, propylene carbonate, lactones, diethylene glycol, triethylene glycol, tetraethylene glycol, decalin, gamma-butyrolactone, dimethylformamide, phenylmethanol, dimethyl sulfoxide (DMSO), and mixtures thereof; and a second solvent selected from the group consisting of water, N-2-hydroxyethyl-2-pyrrolidone, 1,6-hexanediol, dimethyl sulfoxide (DMSO), isopropyl alcohol, ethanol, acetone, and mixtures thereof. In this example, the first solvent is present in the first-generation fusing agent in an amount ranging from about 1 wt % active to about 20 wt % active, and the second solvent is present in an amount ranging from about 30 wt % active to about 55 wt % active, based on a total weight of the first-generation fusing agent.

In addition to the plasticizing solvent package described herein, the first-generation fusing agent also includes water and, in some instances, additives. These liquid components make up a liquid vehicle of the first-generation fusing agent. Examples of the additives include surfactants, antimicrobial agents, chelating agents, anti-kogation agents, buffers, and combinations thereof. In an example, the first-generation fusing agent consists of the plasticizing solvent package, water, and the energy absorber. In another example, the first-generation fusing agent consists of the plasticizing solvent package, water, the energy absorber, and a surfactant.

The first-generation fusing agent may further include a surfactant as the additive. Examples of surfactants that may be used for the first-generation fusing agent include non-ionic or anionic surfactants. Some example surfactants include alkyl polyethylene oxides, alkyl phenyl polyethylene oxides, polyethylene oxide block copolymers, acetylenic polyethylene oxides, polyethylene oxide (di) esters, polyethylene oxide amines, dimethicone copolyols, substituted amine oxides, fluorosurfactants, and the like. Some examples of these surfactants include a self-emulsifiable, non-ionic wetting agent based on acetylenic diol chemistry (e.g., SURFYNOL® SEF from Evonik Degussa), a non-ionic fluorosurfactant (e.g., CAPSTONE® fluorosurfactants, such as CAPSTONE® FS-35, from Chemours), an ethoxylated low-foam wetting agent (e.g., SURFYNOL® 440 or SURFYNOL® CT-111 from Evonik Degussa), an ethoxylated wetting agent and molecular defoamer (e.g., SURFYNOL® 420 from Evonik Degussa), non-ionic wetting agents and molecular defoamers (e.g., SURFYNOL® 104E from Evonik Degussa), and/or water-soluble, non-ionic surfactants (e.g., TERGITOL™ TMN-6, TERGITOL™ 15-S-7, or TERGITOL™ 15-S-9 (a secondary alcohol ethoxylate) from The Dow Chemical Company or TEGO® Wet 510 (organic surfactant) available from Evonik Degussa). Yet another anionic surfactant includes alkyldiphenyloxide disulfonate (e.g., the DOWFAX™ series, such a 2A1, 3B2, 8390, C6L, C10L, and 30599, from The Dow Chemical Company).

Whether a single surfactant is used, or a combination of surfactants is used, the total amount of surfactant(s) ranges from about 0.01 wt % active to about 2 wt % active, based on the total weight of the first-generation fusing agent. In another example, the total amount of surfactant(s) present in the first-generation fusing agent ranges from about 0.05 wt % active to about 1 wt % active, based on the total weight of the first-generation fusing agent. In another example, the total amount of surfactant(s) used is about 0.70 wt % active, based on the total weight of the first-generation fusing agent.

Antimicrobial agents are also known as biocides and/or fungicides. Examples of suitable antimicrobial agents that may be used as an additive in the fusing agent include NUOSEPT® (Ashland Inc.), UCARCIDE™ or KORDEK™ or ROCIMA™ (The Dow Chemical Company), PROXEL® (Arch Chemicals) series, ACTICIDE® B20 and ACTICIDE® M20 and ACTICIDE® MBL (blends of 2-methyl-4-isothiazolin-3-one (MIT), 1,2-benzisothiazolin-3-one (BIT) and Bronopol) (Thor Chemicals), AXIDE™ (Planet Chemical), NIPACIDE™ (Clariant Int. Ltd.), blends of 5-chloro-2-methyl-4-isothiazolin-3-one (CIT or CMIT) and MIT under the tradename KATHON™ (The Dow Chemical Company), and combinations thereof.

In an example, the total amount of antimicrobial agent(s) ranges from about 0.01 wt % active to about 0.05 wt % active, based on the total weight of the first-generation fusing agent.

Chelating agents (or sequestering agents) may be included in the fusing agent to eliminate the deleterious effects of heavy metal impurities. In an example, the chelating agent is selected from the group consisting of methylglycinediacetic acid, trisodium salt; 4,5-dihydroxy-1,3-benzenedisulfonic acid disodium salt monohydrate; ethylenediaminetetraacetic acid (EDTA); hexamethylenediamine tetra(methylene phosphonic acid), potassium salt; and combinations thereof. Methylglycinediacetic acid, trisodium salt (Na3MGDA) is commercially available as TRILON® M from BASF Corp. 4,5-dihydroxy-1,3-benzenedisulfonic acid disodium salt monohydrate is commercially available as TIRON™ monohydrate. Hexamethylenediamine tetra(methylene phosphonic acid), potassium salt is commercially available as DEQUEST® 2054 from Italmatch Chemicals.

Whether a single chelating agent is used or a combination of chelating agents is used, the total amount of chelating agent(s) may range from greater than 0 wt % active to about 0.5 wt % active, based on the total weight of the first-generation fusing agent.

In some examples, the additive in the fusing agent is an anti-kogation agent. “Kogation” refers to the deposit of dried printing liquid (e.g., the fusing agent) on a heating element of a thermal inkjet printhead. Anti-kogation agent(s) is/are included to assist in preventing the buildup of kogation. Examples of anti-kogation agents include oleth-3-phosphate (commercially available as CRODAFOS™ O3A or CRODAFOS™ N-3A) or dextran 500,000. Other examples of the anti-kogation agents include CRODAFOS™ HCE (a phosphate-ester from Croda Int.), CRODAFOS® O10A (oleth-10-phosphate from Croda Int.), and DISPERSOGEN® LFH (a polymeric dispersing agent with aromatic anchoring groups, acid form, anionic, from Clariant Int. Ltd.), etc. It is to be understood that any combination of the anti-kogation agents listed may be used.

In an example, the total amount of anti-kogation agent(s) may range from greater than 0 wt % active to about 0.5 wt % active, based on the total weight of the first-generation fusing agent.

The liquid vehicle may also include a buffer. Examples of suitable buffers include tris(Hydroxymethyl)aminomethane based buffers, such as TRIS and TRIZMA, and (4-(2-hydroxyethyl)-1-piperazineethanesulfonic acid) (HEPES).

In an example, the total amount of buffer(s) may range from 0.01 wt % active to about 1 wt % active, based on the total weight of the first-generation fusing agent.

In addition to the plasticizing solvent package, the liquid vehicle of the first-generation fusing agent further includes water. The water generally makes up a balance of the first-generation fusing agent, relative to the other components included in the fusing agent (e.g., the plasticizing solvent package, energy absorber, and any additives included in the fusing agent). The amount of water included in the first-generation fusing agent depends upon the amount of each of the other components included in the first-generation fusing agent. In an example, the amount of water present in the first-generation fusing agent ranges from 25 wt % to about 70 wt %, based on the total weight of the first-generation fusing agent. In another example, the amount of water preset in the fusing agent ranges from 30 wt % to 66 wt %, based on the total weight of the first-generation fusing agent. The water may be pure water, deionized water (DI water), distilled water, or any other suitable form of water.

Table 1 below illustrates an example formulation of the first-generation fusing agent that may be used:

TABLE 1

| Component | % active | Wt % |
|---|---|---|
| Urea | 100 | 1-20 |
| Solvent(s) | 100 | 33-52 |
| Acid Yellow 250 | >98 | 0.01-0.35 |
| Surfactant | 100 | 0.75 |
| Water | 100 | Balance |

Any example of the first-generation fusing agent set forth herein can be used in a 3D printing method, which selectively applied the first-generation fusing agent to a build material composition. The first-generation fusing agent may be used in the 3D printing method with or without a detailing agent. The detailing agent and the build material composition are described further below.

### Detailing Agent

The 3D printing methods described herein may also use a detailing agent. The detailing agent may include a surfactant, a co-solvent, and a balance of water. In an example, the detailing agent consists of these components and no other components. In another example, the detailing agent further includes additional components, such as anti-kogation agent(s), antimicrobial agent(s), and/or chelating agent(s), each of which is described above in reference to the first-generation fusing agent. The balance of the detailing agent is water. As such, the amount of water may vary depending upon the amounts of the other components that are included in the detailing agent.

Suitable surfactant(s) for the detailing agent include any of the non-ionic or anionic surfactants set forth herein for the first-generation fusing agent, an any of the amounts set forth herein for the first-generation fusing agent.

The detailing agent may include co-solvent(s). Classes of water-soluble or water-miscible organic co-solvents that may be used in the detailing agent include aliphatic alcohols, aromatic alcohols, diols, glycol ethers, polyglycol ethers, lactams, formamides (substituted and unsubstituted), acetamides (substituted and unsubstituted), glycols, and long chain alcohols. Examples of these co-solvents include primary aliphatic alcohols, secondary aliphatic alcohols, 1,2-alcohols, 1,3-alcohols, 1,5-alcohols, other diols (e.g., 2-methyl-1,3-propanediol, etc.), ethylene glycol alkyl ethers, propylene glycol alkyl ethers, higher homologs (C6-C12) of polyethylene glycol alkyl ethers, triethylene glycol, tetraethylene glycol, tripropylene glycol methyl ether, N-alkyl caprolactams, unsubstituted caprolactams, 1-methyl-2-pyrrolidone, 2-pyrrolidone, and the like. Other examples of suitable organic co-solvents include dimethyl sulfoxide (DMSO), isopropyl alcohol, ethanol, pentanol, acetone, or the like.

The examples of the detailing agent disclosed herein do not include a colorant. As such, the detailing agent may be colorless. As used in this context, “colorless” means that the detailing agent is achromatic and does not include a colorant.

The examples of the detailing agent disclosed herein do not include an energy absorber. As such, the detailing agent does not absorb energy to aid in coalescence.

The detailing agent, in combination with the first- or second-generation fusing agent, may be used to generate 3D object layer(s)/object(s) as described in the 3D printing methods.

### Build Material Composition

The first- or second-generation fusing agents of the present disclosure are used in examples of the 3D printing method to pattern a polymeric build material composition (referred to interchangeably herein as the “build material composition” or simply “build material”). Some examples of suitable polymeric materials for the polymeric build material composition include polyamides, polyacetals, polyolefins, styrene copolymers, acrylic polymers and copolymers, polyethers, polyaryletherketones, polyesters (e.g., a thermoplastic copolyester (TPC)), polycarbonates (PC), a thermoplastic polyurethane elastomer (TPU), a thermoplastic polyolefin elastomer (TPO), a polyether block amide (PEBA), or a combination thereof. In an example, the polymer material is selected from the group consisting of polyethylene, polyethylene terephthalate (PET), polypropylene, high density polyethylene (HDPE), polyoxymethylene (POM), polyether ketone (PEK), polyether ether ketone (PEEK), polyetherketoneketone (PEKK), polyphenylene sulfide (PPS), acrylonitrile styrene acrylate (ASA), poly(methyl methacrylate) (PMMA), styrene acrylonitrile (SAN), styrene maleic anhydride (SMA), poly(vinyl chloride) (PVC), polyethylenimine (PEI), and combinations thereof. In some instances, the polymeric material may be referred to herein as an elastomer.

In some examples, the polymeric build material composition is a polyamide build material composition including polyamide particles. Examples of suitable polyamides include polyamide-11 (PA 11/nylon 11), polyamide-12 (PA 12/nylon 12), polyamide-6 (PA 6/nylon 6), polyamide-8 (PA 8/nylon 8), polyamide-9 (PA 9/nylon 9), polyamide-66 (PA 66/nylon 66), polyamide-612 (PA 612/nylon 612), polyamide-812 (PA 812/nylon 812), polyamide-912 (PA 912/nylon 912), etc., a thermoplastic polyamide (TPA), and combinations thereof.

The polymeric material may be made up of similarly sized particles and/or differently sized particles. In an example, the average particle size of the polymeric material ranges from about 2 μm to about 225 μm. In another example, the average particle size of the polymeric material ranges from about 10 μm to about 130 μm. The term “average particle size,” as used herein, refers to a volume-weighted mean diameter of a particle distribution.

In some examples, in addition to the polymeric material, the build material composition may include an antioxidant, a whitener, an antistatic agent, a flow aid, or a combination thereof. While several examples of these additives are provided, it is to be understood that these additives are selected to be thermally stable (i.e., will not decompose) at the 3D printing temperatures.

Antioxidant(s) may be added to the build material composition to prevent or slow molecular weight decreases of the polymeric material and/or to prevent or slow discoloration (e.g., yellowing) by preventing or slowing oxidation of the polymeric material. In some examples, the polymeric material may discolor upon reacting with oxygen, and this discoloration may contribute to the discoloration of the build material composition. The antioxidant may be selected to minimize discoloration. In some examples, the antioxidant may be a radical scavenger. In these examples, the antioxidant may include IRGANOX® 1098 (benzenepropanamide, N,N′-1,6-hexanediylbis(3,5-bis(1,1-dimethylethyl)-4-hydroxy)), IRGANOX® 254 (a mixture of 40% triethylene glycol bis(3-tert-butyl-4-hydroxy-5-methylphenyl), polyvinyl alcohol and deionized water), and/or other sterically hindered phenols. In other examples, the antioxidant may include a phosphite and/or an organic sulfide (e.g., a thioester). The antioxidant may be in the form of fine particles (e.g., having an average particle size of 5 μm or less) that are dry blended with the polymeric material.

In an example, the antioxidant may be included in the build material composition in an amount ranging from about 0.01 wt % to about 5 wt %, based on the total weight of the build material composition. In other examples, the antioxidant may be included in the build material composition in an amount ranging from about 0.01 wt % to about 2 wt % or from about 0.2 wt % to about 1 wt %, based on the total weight of the build material composition.

Whitener(s) may be added to the build material composition to bring the L* of the build material composition closer to 100 (white) and/or improve visibility. It is to be understood, however, that some examples of the build material composition do not include the whitener. Examples of suitable whiteners include titanium dioxide (TiO₂), zinc oxide (ZnO), calcium carbonate (CaCO₃), zirconium dioxide (ZrO₂), aluminum oxide (Al₂O₃), silicon dioxide (SiO₂), boron nitride (BN), barium sulfate, and combinations thereof. In some examples, a stilbene derivative may be used as the whitener and a brightener. In these examples, the temperature(s) of the 3D printing process may be selected so that the stilbene derivative remains stable (i.e., the 3D printing temperature does not thermally decompose the stilbene derivative).

Any example of the whitener may be included in the build material composition in an amount ranging from greater than 0 wt % to about 10 wt %, based on the total weight of the build material composition.

Antistatic agent(s) may be added to the polymeric build material composition to suppress tribo-charging. Examples of suitable antistatic agents include aliphatic amines (which may be ethoxylated), aliphatic amides, quaternary ammonium salts (e.g., behentrimonium chloride or cocamidopropyl betaine), esters of phosphoric acid, polyethylene glycolesters, or polyols. Some suitable commercially available antistatic agents include HOSTASTAT® FA 38 (natural based ethoxylated alkylamine), HOSTASTAT® FE2 (fatty acid ester), and HOSTASTAT® HS 1 (alkane sulfonate), each of which is available from Clariant Int. Ltd.).

In an example, the antistatic agent is added in an amount ranging from greater than 0 wt % to less than 5 wt %, based upon the total weight of the build material composition.

Flow aid(s) may be added to improve the coating flowability of the polymeric build material composition. Flow aids may be particularly beneficial when the polymeric material in the build material composition has an average particle size less than 25 μm. The flow aid improves the flowability of the build material composition by reducing the friction, the lateral drag, and the tribocharge buildup (by increasing the particle conductivity). Examples of suitable flow aids include aluminum oxide (Al2O₃), tricalcium phosphate (E341), powdered cellulose (E460 (ii)), magnesium stearate (E470b), sodium bicarbonate (E500), sodium ferrocyanide (E535), potassium ferrocyanide (E536), calcium ferrocyanide (E538), bone phosphate (E542), sodium silicate (E550), silicon dioxide (E551), calcium silicate (E552), magnesium trisilicate (E553a), talcum powder (E553b), sodium aluminosilicate (E554), potassium aluminum silicate (E555), calcium aluminosilicate (E556), bentonite (E558), aluminum silicate (E559), stearic acid (E570), and polydimethylsiloxane (E900).

In an example, the flow aid is added in an amount ranging from greater than 0 wt % to less than 5 wt %, based upon the total weight of the build material composition.

### 3D Printing Method Using the First-Generation Fusing Agent

An example of a 3D printing method that utilizes the first-generation fusing agent to generate the initial 3D printed object is described in detail below.

Prior to execution of the method, it is to be understood that a controller may access data stored in a data store pertaining to the initial 3D solid part (or 3D printed object) that is to be made/printed. For example, the controller may determine the number of layers of a build material composition that are to be formed, the locations at which the first-generation fusing agent (and detailing agent, if used) is to be deposited on each of the respective layers, etc.

The method includes applying the polymeric build material composition to form a build material layer, and based on a 3D object model, selectively applying the first-generation fusing agent onto at least a portion of the build material layer, thereby forming a patterned portion. The first-generation fusing agent used in the method may be any of the examples described herein. In another example, the method further includes, based on the 3D object model, applying the detailing agent onto another portion of the build material layer.

In an example method, a layer of the build material composition is applied on a build area platform. It is to be understood that any of the polymeric build materials described herein may be used in the method as or in the build material composition. A printing system may be used to apply the build material composition. The printing system may include the build area platform, a build material supply containing the build material composition, and a build material distributor.

The build area platform receives the build material composition from the build material supply. The build area platform may be moved in various directions so that the build material composition may be delivered to the build area platform or to a previously formed layer. In an example, when the build material composition is to be delivered, the build area platform may be programmed to advance (e.g., downward or in the Z direction relative to the X-Y plane of the build area platform) enough so that the build material distributor can push the build material composition onto the build area platform to form a substantially uniform layer of the build material composition thereon. The build area platform may also be returned to its original position, for example, when a new part is to be built.

The build material supply may be a container, bed, or other surface that is to position the build material composition between the build material distributor and the build area platform. The build material supply may include heaters so that the build material composition is heated to a supply temperature ranging from about 25° C. to about 200° C. In these examples, the supply temperature may depend, in part, on the build material composition used and/or the 3D printer used. As such, the range provided is one example, and higher or lower temperatures may be used.

The build material distributor may be moved in various directions, over the build material supply and across the build area platform to spread the layer of the build material composition over the build area platform. The build material distributor may also be returned to a position adjacent to the build material supply following the spreading of the build material composition. The build material distributor may be a blade (e.g., a doctor blade), a roller, a combination of a roller and a blade, and/or any other device capable of spreading the build material composition over the build area platform. For instance, the build material distributor may be a counter-rotating roller. In some examples, the build material supply or a portion of the build material supply may translate along with the build material distributor such that build material composition is delivered continuously to the build area platform.

The build material supply may supply the build material composition into a position so that it is ready to be spread onto the build area platform. The build material distributor may spread the supplied build material composition onto the build area platform. The controller may process “control build material supply” data, and in response, control the build material supply to appropriately position the particles of the build material composition, and may process “control spreader” data, and in response, control the build material distributor to spread the build material composition over the build area platform to form the layer.

The build material layer has a substantially uniform thickness across the build area platform. In an example, the build material layer has a thickness ranging from about 50 μm to about 120 μm. In another example, the thickness of the build material layer ranges from about 30 μm to about 300 μm. It is to be understood that thinner or thicker layers may also be used. For example, the thickness of the build material layer may range from about 20 μm to about 500 μm. The layer thickness may be about 2× (i.e., 2 times) the average diameter of the polymeric material at a minimum for finer part definition. In some examples, the layer thickness may be about 1.2× the average diameter of the polymeric material in the build material composition.

After the build material composition has been applied, and prior to further processing, the build material layer may be exposed to heating. In an example, the heating temperature may be below the melting point or melting range of the polymeric material in the build material composition. As examples, the pre-heating temperature may range from about 5° C. to about 50° C. below the melting point or the lowest temperature of the melting range of the polymeric material. In an example, the pre-heating temperature ranges from about 50° C. to about 205° C. In still another example, the pre-heating temperature ranges from about 100° C. to about 190° C. It is to be understood that the pre-heating temperature may depend, in part, on the build material composition used. As such, the ranges provided are some examples, and higher or lower temperatures may be used.

Pre-heating the layer may be accomplished by using any suitable heat source that exposes all of the build material composition in the build material layer to the heat. Examples of the heat source include a thermal heat source (e.g., a heater integrated into the build area platform (which may include sidewalls)) or a radiation source. After the layer is formed, and in some instances is pre-heated, the first-generation fusing agent is selectively applied on at least some of the build material composition in the layer to form a patterned portion.

The amount of the first-generation fusing agent that is applied per unit of the build material composition in the patterned portion may be sufficient to absorb and convert enough energy so that the build material composition in the patterned portion will coalesce. The amount of the first-generation fusing agent that is applied per unit of the build material composition may depend, at least in part, on the loading of the dye or colorless UV-light absorber in the first-generation fusing agent, and the type of polymeric material in the build material composition. In particular, the concentration of the dye or colorless UV-light absorber in the first-generation fusing agent can be considered. This concentration can be used to determine how much of the first-generation fusing agent to apply to achieve a weight ratio of dye/colorless UV-light absorber to build material composition for acceptable layer-by-layer fusing. If applying the second-generation fusing agent to the build material composition at a weight ratio of about 1:9, then the extracted dye/absorber to build material composition weight ratio (as applied) can be from about 1:90,000 to about 3.5:9,000. If more or less of the fusing agent is applied to the build material composition, then these ratios can be adjusted accordingly.

The first-generation fusing agent may be dispensed from an applicator. The applicator may include a thermal inkjet printhead, a piezoelectric printhead, a continuous inkjet printhead, etc. in fluid communication with a fluid reservoir/container, and the selective application of the fusing agent may be accomplished by thermal inkjet printing, piezo electric inkjet printing, continuous inkjet printing, etc. The controller may process data, and in response, control the applicator to deposit the fusing agent onto pre-determined portion(s) of the build material composition to generate the patterned portion.

In some examples, the method further comprises selectively applying, based on the 3D object model, the detailing agent onto another portion of the build material layer outside of the patterned portion. The detailing agent may be selectively applied to the portion(s) of the layer that are not patterned with the first-generation fusing agent, and thus that are not to become part of a final 3D object layer. Thermal energy generated during radiation exposure may propagate into the surrounding portion(s) that do not have the first-generation fusing agent applied thereto. The propagation of thermal energy may be inhibited and, in turn, the coalescence of the non-patterned build material portion(s) may be prevented when the detailing agent is applied to these other portion(s).

In some other examples, the detailing agent may also or alternatively be applied to the patterned portion or a portion of the patterned portion (i.e., with the first-generation fusing agent). The detailing agent may be applied to the patterned portion to provide a cooling effect so that the build material does not overheat and/or to lower the extent of fusing in the area patterned with both the first-generation fusing agent and the detailing agent. In these examples, the amount of the detailing agent that is applied should be low enough so that fusing is not completely inhibited. In other examples, the detailing agent and the first-generation fusing agent may intermingle at the edge(s) between the patterned portion and the other portion(s).

The detailing agent may be dispensed from an applicator. The applicator may include a thermal inkjet printhead, a piezoelectric printhead, a continuous inkjet printhead, etc. in fluid communication with a fluid reservoir/container, and the selective application of the detailing agent may be accomplished by thermal inkjet printing, piezo electric inkjet printing, continuous inkjet printing, etc. The controller may process data, and in response, control the applicator to deposit the detailing agent onto pre-determined portion(s) of the build material composition to generate the portion(s).

It is to be understood that the selective application of any of the first-generation fusing agent and/or the detailing agent may be accomplished in a single printing pass or in multiple printing passes. In some examples, the agent(s) is/are selectively applied in a single printing pass. In some other examples, the agent(s) is/are selectively applied in multiple printing passes. In one of these examples, the number of printing passes ranges from 2 to 4. The first-generation fusing agent and/or the detailing agent may be applied in multiple printing passes to increase the amount, which is applied to the build material composition, to avoid liquid splashing, to avoid displacement of the build material composition, etc.

After the first-generation fusing agent and/or detailing agent are selectively applied in the specific portion(s) of the layer, the entire layer of the build material composition is exposed to electromagnetic radiation. In an example, the entire layer of the build material composition is exposed to electromagnetic radiation in the form of visible light in instances where the first-generation fusing agent includes a visible-light absorbing dye. In another example, the entire layer of the build material composition is exposed to electromagnetic radiation in the form of UV electromagnetic energy in instances where the first-generation fusing agent includes either a UV-light absorbing dye or a colorless UV light absorber. The electromagnetic radiation is emitted from an electromagnetic radiation source, such as a visible light source or a UV radiation source. For visible light, the radiation source may include visible light lamps, visible light emitting diodes (LEDs), or another broad-spectrum light source emitting the suitable visible light wavelength(s). For UV light, the radiation source may include UV-Visible wavelength light emitting diodes, UV lamps, UV lasers, or another broad- or narrow-spectrum light source emitting the wavelength(s). The length of time the electromagnetic radiation is applied for, or energy exposure time, may be dependent, for example, on: characteristics of the radiation source; characteristics of the build material composition; and/or characteristics of the first-generation fusing agent. In an example, a single point of the build material layer is exposed to electromagnetic radiation for a period of time ranging from 0.01 second to 1 second.

It is to be understood that the electromagnetic radiation exposure may be accomplished in a single radiation event or in multiple radiation events. The term “event,” as used herein, refers to one period of exposure of electromagnetic radiation from the radiation source. In an example, a radiation event may occur as a pass of a moveable radiation source over the build material layer (similar to a printing pass). In an example, the exposing of the build material composition is accomplished in multiple radiation events. In a specific example, the number of radiation events ranges from 1 to 8. In still another specific example, the exposure of the build material composition to electromagnetic radiation may be accomplished in 3 radiation events. The build material composition may be exposed to electromagnetic radiation in multiple radiation events to counteract a cooling effect that may be brought on by the amount of the first-generation fusing agent, alone or in combination with the detailing agent, that is applied to the build material layer. Additionally, the build material composition may be exposed to electromagnetic radiation in multiple radiation events to sufficiently elevate the temperature of the build material composition in the portion(s) without overheating the build material composition in the non-patterned portion(s).

The first-generation fusing agent enhances the absorption of the radiation, converts the absorbed radiation to thermal energy, and promotes the transfer of the thermal energy (heat) to the build material composition in contact therewith. In an example, the first-generation fusing agent sufficiently elevates the temperature of the build material composition in the portion to a temperature above the melting point or within the melting range of the polymeric material, allowing coalescing/fusing (e.g., thermal merging, melting, binding, etc.) of the build material composition to take place. The application of the electromagnetic radiation forms the 3D object layer.

In examples where the first-generation fusing agent includes a visible light-absorbing dye, the electromagnetic radiation has a wavelength ranging from 380 nm to 700 nm. In other examples where the first-generation fusing agent includes a UV-light absorbing dye or a colorless UV-light absorber, the electromagnetic radiation has a wavelength ranging from 10 nm to 400 nm. Radiation having wavelengths within the provided ranges may be substantially absorbed (e.g., 80% or more of the applied radiation is absorbed) by the fusing agent and may heat the build material composition in contact therewith. Further, the radiation may not be substantially absorbed (e.g., 25% or less of the applied radiation is absorbed) by the non-patterned build material composition in portion(s).

After the 3D object layer is formed, additional layer(s) may be formed thereon to create an example of the initial 3D printed object. To form the next layer, additional build material composition may be applied on the 3D object layer. The first-generation fusing agent is then selectively applied on at least a portion of the additional build material composition, according to the 3D object model. The detailing agent may be applied in any area of the additional build material composition where coalescence is not supposed to take place and/or where the extent of fusing is to be reduced. After the first-generation fusing agent and/or detailing agent is/are applied, the entire additional layer of the additional build material composition is exposed to electromagnetic radiation in the manner described herein. The application of additional build material composition, the selective application of the first-generation fusing agent, alone or in combination with the detailing agent, and the electromagnetic radiation exposure may be repeated for a predetermined number of cycles to form the final 3D object in accordance with the 3D object model. As such, some examples of the method include repeating the applying of the build material composition, the selectively applying of the first-generation fusing agent, and the exposing, to form a predetermined number of 3D object layers and the initial 3D printed object.

The initial 3D printed object may be printed in any orientation. For example, the initial 3D object can be printed from bottom to top, top to bottom, on its side, at an angle, or any other orientation. The orientation of the 3D object can also be formed in any orientation relative to the layering of the build material composition. For example, the 3D object can be formed in an inverted orientation or on its side relative to the layering of the build material composition. The orientation of the build within each layer can be selected in advance or even by the user at the time of printing, for example.

Examples of the method described herein may be used to generate individual 3D object layers that make up the initial 3D printed object/part. The initial 3D printed object contains the energy absorber embedded within the matrix of the coalesced build material polymer. By “embedded,” it is meant that the absorber has penetrated into or is bonded to a surface of the coalesced build material polymer.

The initial 3D printed object may exhibit a color of the dye used as the absorber or may exhibit the color of the build material when the colorless UV absorber is used. By “exhibits a color,” it is meant that the color of initial 3D printed object to closely resembles the color of the energy absorber included in the first-generation fusing agent.

The initial 3D printed object may be used in either of the additional methods set forth herein to create a second-generation product.

### Absorber Recycling

In one example method, the initial 3D printed object is exposed to an extraction process to extract the energy absorber therefrom, which is then recycled into another fusing agent. The fusing agent formulation including the extracted energy absorber is referred to herein as a second-generation fusing agent. The second-generation fusing agent can be used in a subsequent 3D printing process to form a new part. An example of a 3D printing method utilizing the second-generation fusing agent is described below.

The extraction process first includes dividing the 3D printed solid part (i.e., the initial 3D printed object) into smaller pieces so that all of the pieces of the 3D printed solid part can fit inside a container selected for use in energy absorber extraction. The average size of the pieces may depend upon the size of the original 3D printed solid part and the size of the container. In instances where larger containers are used, a smaller number of larger pieces may be able to fit inside the container. Conversely, in instances where smaller containers are used, a larger number of smaller pieces of the 3D printed solid part may be able to fit inside the container. The number of pieces may also be dependent on the size of the initial 3D printed object. For example, larger objects may be divided into a larger number of smaller pieces compared to smaller objects. Additionally, each piece can have any size that can fit into the selected container, and the size of the pieces can be uniform or non-uniform. In an example, the initial 3D printed solid part is divided up into two, three, four, or more pieces. In another example, the initial 3D printed object is divided up into several smaller pieces (e.g., tens to hundreds), such that the smaller pieces are fragments of the initial 3D printed object.

Once the initial 3D printed solid part has been divided up into smaller pieces, the method includes exposing the smaller pieces to an aqueous solution for a predetermined time. The aqueous solution includes water and ethanol. In an example, the aqueous solution includes from about 10 wt % active to about 80 wt % active of ethanol and a balance of water. Water alone is insufficient for extraction, as the energy absorber becomes fused into the coalesced polymer matrix. A higher ethanol content in the aqueous solution aids in speeding up the extraction since it is more miscible with the coalesced polymer matrix than the water. It is believed that organic solvents that are capable of dissolving the dye and that are more aggressive than ethanol may be used, as long as it can be removed when condensing the extract.

In an example, the pieces of the 3D printed solid part are placed inside the container, and then the container is filled with the aqueous solution until all of the pieces of the object are submerged in the aqueous solution. The smaller pieces are exposed to the aqueous solution for a predetermined time that is sufficient to extract or leech the energy absorber from the pieces of the 3D printed solid part. The predetermined time may be dependent on the size of the pieces and the type of absorber to be removed. Additionally, the container including the submerged pieces is sealed (such as by securing a lid on the container) and then heated, e.g., by placing the container onto a hot plate or into an oven at a temperature ranging from about 60° C. to about 80° C. In a particular example, the container is placed into an oven at a temperature of 70° C. The time for heating may range from about 10 hours to about 170 hours, depending, upon how much of the energy absorber is to be extract. As another example, the time for heating ranges from about 10 hours to about 120 hours, depending, upon how much of the energy absorber is to be extract. A longer time leads to more extracted energy absorber. In an example, the container remains in the oven for a predetermined time of about seven days (˜168 hours).

After the predetermined time, the container can be removed from the heat source and allowed to cool to room temperature. The contents of the container include the extracted absorber, the aqueous solution of ethanol and water, and chunks or fragments of polymer from the pieces of the initial 3D object. These pieces may be intact or may have degraded some during the extraction process.

The energy absorber that is extracted will depend upon the energy absorber included in the first-generation fusing agent that had been used to form the initial 3D printed object. The extracted energy absorber may be an extracted dye. IN one example, the extracted dye is an ultraviolet-light absorbing dye selected from the group consisting of pyranine, a pyranine derivative, coumarin, a coumarin derivative, a naphthalimide, a naphthalimide derivative, a disazomethine derivative, aldazine, and mixtures thereof. In another example, the extracted dye is selected from the group consisting of solvent green 7, acid yellow 184, Acid Yellow 250, Yellow 101, Basic Yellow 40, Solvent Yellow 43, Solvent Yellow 44, Solvent Yellow 85, Solvent Yellow 145, Solvent Yellow 160:1, and combinations thereof. The extracted energy absorber may alternatively be an extracted colorless UV energy absorber. In one example, the extracted colorless ultraviolet-light absorber is selected from the group consisting of benzotriazolyl dodecyl p-cresol, avobenzone, and diethylamino hydroxybenzoyl hexyl benzoate.

The method further includes generating an absorber extract solution. First, the contents of the container can be passed through a sieve to remove larger pieces of the initial 3D printed solid part and/or passed through a filter to remove smaller fragments of the initial 3D printed solid part. The amount of absorber present in the filtered solution is less than 1 wt % of the total weight of the filtered solution. In order to increase the concentration of the extracted energy absorber, the filtered solution is placed back into the oven at a temperature ranging from about 90° C. to about 100° C. to evaporate the ethanol and at least some of the water. In one example, the total volume of the extract after heating is about 40 mL. The extract may contain water with a small amount of the energy absorber.

A solvent, alone or in combination with a surfactant, may then be combined with the concentrated extract to form the absorber extract solution. Combining may include mixing, blending, or the like.

The solvent may be propylene glycol or oligomers thereof (up to N=4), ethylene glycol or oligomers thereof (up to N=4), 1-(2-hydroxyethyl)-2-pyrrolidone (HE2P), or other similar solvents, and the surfactant may be any of the surfactants set forth herein. In one example, the absorber extract solution includes from about 0.01 wt % to about 3 wt % of the extracted dye, based on a total weight of the absorber extract solution, from about 0.01 wt % to about 10 wt % of propylene glycol or oligomers thereof (up to N=4), ethylene glycol or oligomers thereof (up to N=4), or 1-(2-hydroxyethyl)-2-pyrrolidone (HE2P), based on the total weight of the absorber extract solution, and a balance of water. In one example, the absorber extract solution includes from about 0.01 wt % to about 3 wt % of the extracted colorless ultraviolet-light absorber, based on a total weight of the absorber extract solution, from about 0.01 wt % to about 10 wt % of propylene glycol or oligomers thereof (up to N=4), ethylene glycol or oligomers thereof (up to N=4), or 1-(2-hydroxyethyl)-2-pyrrolidone (HE2P), based on the total weight of the absorber extract solution, and a balance of water. In one specific example, the absorber extract solution includes about 0.75 wt % surfactant, about 15 wt % propylene glycol, and about 84.25 wt % of the concentrated extract, which includes water and from about 0.01 wt % to about 3 wt % of the extracted dye/colorless absorber).

The method further includes formulating the second-generation fusing agent from the absorber extract solution. The absorber extract solution can be combined with a liquid vehicle to form the second-generation fusing agent.

One specific example of the absorber recycling method disclosed herein includes dividing a thermoplastic polyamide 3D printed object into smaller pieces; exposing the smaller pieces to an aqueous solution including from about 10 wt % active to about 80 wt % active of ethanol for a predetermined period of time, thereby extracting a radiation absorbing dye or a colorless ultraviolet light absorber from the thermoplastic polyamide 3D printed object; generating an absorber extract solution from the extracted radiation absorbing dye or colorless ultraviolet-light absorber; and formulating a second-generation fusing agent from the absorber extract solution.

### Second-Generation Fusing Agent

As mentioned, the absorber extract solution can be combined with a liquid vehicle to form the second-generation fusing agent. In one example, the second-generation fusing agent includes from about 10 wt % active to about 50 wt % active of a plasticizing solvent; from about 30 wt % active to about 50 wt % active of a water miscible co-solvent; and from about 10 wt % and about 30 wt % of an absorber extract solution, wherein each wt % is based on a total weight of the second-generation fusing agent.

The absorber extract solution may be any of the examples set forth herein. As described herein, the extracted energy absorber in the absorber extract solution comes from the initial 3D printed object, and thus may be any examples of the dye or colorless UV light absorber set forth herein. Also as described herein, the absorber extract solution includes propylene glycol and water, with or without a surfactant.

The absorber extract solution is combined with the plasticizing solvent and the water miscible co-solvent. The plasticizing solvent is an aromatic alcohol and the water miscible co-solvent increases the water solubility of the aromatic alcohol.

The aromatic alcohol can be benzyl alcohol (which has the formula C₆H₅CH₂OH) or 2-phenoxyethanol. The aromatic alcohol is present in the second-generation fusing agent in an amount ranging from about 10 wt % active to about 50 wt % active, based on the total weight of the second-generation fusing agent. In another example, the aromatic alcohol is present in the second-generation fusing agent in an amount ranging from about 10 wt % active to about 25 wt % active, based on the total weight of the second-generation fusing agent. In still another example, the aromatic alcohol is present in the second-generation fusing agent in an amount ranging from about 15 wt % active to about 45 wt % active, based on the total weight of the second-generation fusing agent.

Examples of the water miscible co-solvent in the second-generation fusing agent include 2-pyrrolidone, 1-(2-hydroxyethyl)-2-pyrrolidone (HE2P), glycerol, isopropylidene glycerol (IPG), 2-methyl-1,3-propanediol, 1,2-butane diol, 1,2-hexanediol, diethylene glycol, triethylene glycol, tetraethylene glycol, dipropylene glycol, diethylene glycol butyl ether, other glycol ethers, poly(ethylene glycol) 300, and combinations thereof. In an example, the water miscible co-solvent is selected from the group consisting of diethylene glycol butyl ether, 1-(2-hydroxyethyl)-2-pyrrolidone (HE2P), and 1,2-hexanediol.

The second-generation fusing agent may also include an additive. The additive(s), if used, are incorporated into the second-generation fusing agent in addition to the plasticizing solvent, the water miscible co-solvent, and the absorber extract solution. Examples of additives include surfactants, antimicrobial agents, chelating agents, anti-kogation agents, buffers, solubilizer(s), and combinations thereof.

Any examples of the surfactants, antimicrobial agents, chelating agents, anti-kogation agents, and buffers set forth herein for the first-generation fusing agent may be used in the second-generation fusing agent. Any of these additives may be included in the respective amounts set forth herein for the first-generation fusing agent, except that they will be with respect to a total weight of the second-generation fusing agent.

The second-generation fusing agent may also include a solubilizer, i.e., a crystallization inhibitor. Example solubilizers include those sold under the tradename KOLLIPHOR® (BASF Corp.), such as KOLLIPHOR® RH40 (a nonionic solubilizer and emulsifying agent obtained by reacting 40 moles of ethylene oxide with 1 mole of hydrogenated castor oil), and those sold under the tradename BRIJ® (Croda Industrial Specialties), such as BRIJ® L23 (tricosaethylene glycol dodecyl ether).

The solubilizer may be present in the second-generation fusing agent in an amount ranging from about 1 wt % active to about 3 wt % active, based on a total weight of the second-generation fusing agent.

The second-generation fusing agent may be formed by combining the absorber extract solution with the plasticizing solvent, the water miscible co-solvent, and, in some instances, the additive(s). The resultant second-generation fusing agent is a mixture, blend, or solution of the aforementioned components.

Table 2 below illustrates an example formulation of the fusing agent that may be used in the present disclosure.

TABLE 2

| Component | Wt % |
|---|---|
| Plasticizing Solvent (e.g., benzyl alcohol) | 10-50 |
| Water Miscible Co-solvent (e.g., HE2P) | 30-50 |
| Dye extract solution | 10-30 |
| Surfactant (e.g., TERGITOL ® 15-S-9) | 0.75 |
| Solubilizing Agent (e.g., KOLLIPHER ® RH40) | 1-3 |

### 3D Printing Method Using the Second-Generation Fusing Agent

The second-generation fusing agent can then be used to print a new 3D object using the same 3D printing process described herein for the first-generation fusing agent, except that the second-generation fusing agent is used in place of the first-generation fusing agent. Thus, the method generally includes generating a new 3D printed part containing multiple fused layers, each of the multiple fused layers being formed by: forming a layer of the polymeric build material composition; based on a 3D object model for the new 3D printed part, selectively applying the second-generation fusing agent to the layer; and exposing the layer to visible light or ultraviolet light (depending upon the extracted energy absorber in the second-generation fusing agent).

The new 3D printed object may exhibit a color of the extracted dye or may exhibit the color of the build material when the extracted colorless UV absorber is present in the second-generation fusing agent.

### Initial 3D Printed Object Recycling

The initial 3D printed object may alternatively be recycled to form a second-generation object.

One example method involves dividing the initial 3D printed solid part (i.e., the initial 3D printed object) into smaller pieces, and injection molding the smaller pieces to form a second-generation object. Another example method involves dividing the initial 3D printed solid part (i.e., the initial 3D printed object) into smaller pieces, extracting the energy absorber from the pieces using the method described herein, and injection molding the smaller pieces.

The initial 3D printed solid part may be cut manually or using an automated process. The average size of the pieces may depend upon the injection molding apparatus that is to be used.

Once the initial 3D printed solid part has been divided up into smaller pieces, the method includes exposing the smaller pieces to injection molding. The resulting part is the second-generation object.

### 3D Printing Kit

In an example, the 3D printing kit includes the first-generation fusing agent and the polymeric build material composition. In another example, the 3D printing kit further includes the detailing agent.

It should be understood that the first-generation fusing agent and the polymeric build material composition (and the detailing agent, when included) of the 3D printing kit may be maintained or contained separately until used together in a 3D printing method described in detail below. The first-generation fusing agent and/or the polymeric build material composition (and/or the detailing agent, when included) may each be contained in a container prior to and during 3D printing, but may be combined together during 3D printing. The containers can be any type of vessel (e.g., reservoir, box, or receptable) made of any material.

### 3D Printed Object

The initial and new 3D printed objects formed by the methods described herein are either colored (as a result of the dye or dye extract) or exhibit the color of the build material (as a result of the colorless UV light absorber). The initial or new 3D printed object includes coalesced polymeric build material and the energy absorber or extracted energy absorber intermingled through the coalesced polymer particles. The 3D printed object includes a plurality of build material layers of coalesced polymeric build material. While most of the solvents (e.g., the aromatic alcohol) are evaporated during printing, a residual amount of the solvent(s) is likely to remain. In an example, less than 3 wt % of the solvent(s) remain in the initial or new 3D printed object.

It is to be understood that other components of the build material composition (e.g., whitener, etc.) and/or components of the first- or second-generation fusing agent that do not evaporate may also be present in the initial or new 3D printed object. The weight percentage of each component may depend on the amount used in the build material composition and/or the fusing agent, the dimensions of the 3D printed object, the amount of the fusing agent applied, the evaporation rate (if any) of the components, and other like conditions or parameters.

To further illustrate the present disclosure, examples are given herein. It is to be understood that these examples are provided for illustrative purposes and are not to be construed as limiting the scope of the present disclosure.

### Examples

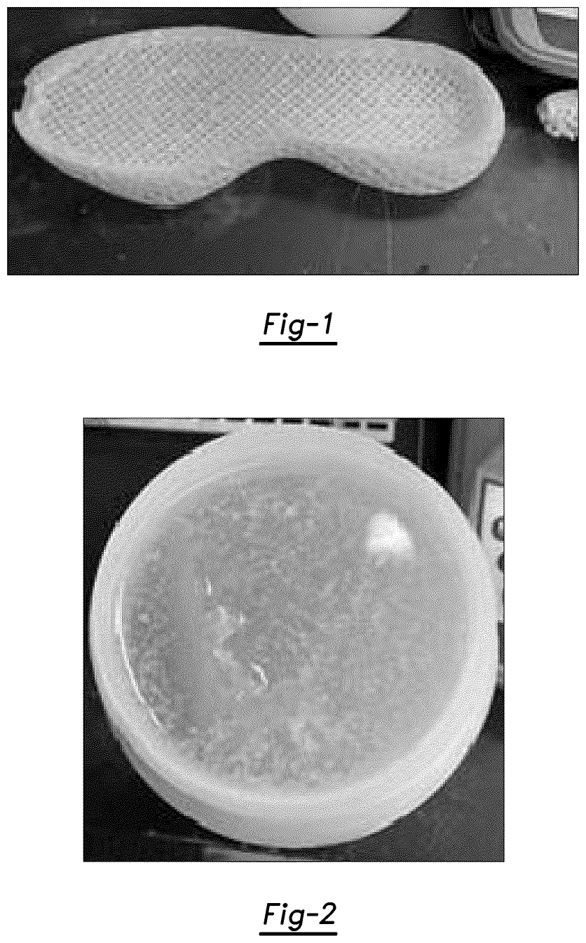

Two 3D objects were printed on a production-scale Multi-Jet Fusion (MJF) 3D printer, each in the shape of a shoe sole. Thermoplastic polyamide powder was used as the build material, and the first-generation fusing agent included Acid Yellow (AY) 23 dye as the energy absorber. A photograph of one of the shoe soles is shown in FIG. 1. Because the AY 23 dye became entrapped within the matrix of the fused/coalesced thermoplastic polyamide build material, the shoe soles exhibited a yellow color.

The shoe soles were then subjected to an extraction process to remove the AY 23 dye from the objects. The shoe soles were cut into smaller pieces. All of the pieces of the shoe soles were placed into a 2L-sized container. A solvent solution of 10 wt % ethanol and 90 wt % water was prepared, and poured into the into the 2L-sized container. The container was filled with the solvent solution, so that all of the shoe sole pieces were submerged, as shown in the photograph in FIG. 2.

The container was sealed utilizing a container lid and then placed into an oven at a temperature of 70° C. for seven days. The AY 23 dye leeched out of the polymer matrix of the thermoplastic polyamide build material during the seven-day period in the oven. Afterwards, the container was removed from the oven and allowed to cool at room temperature.

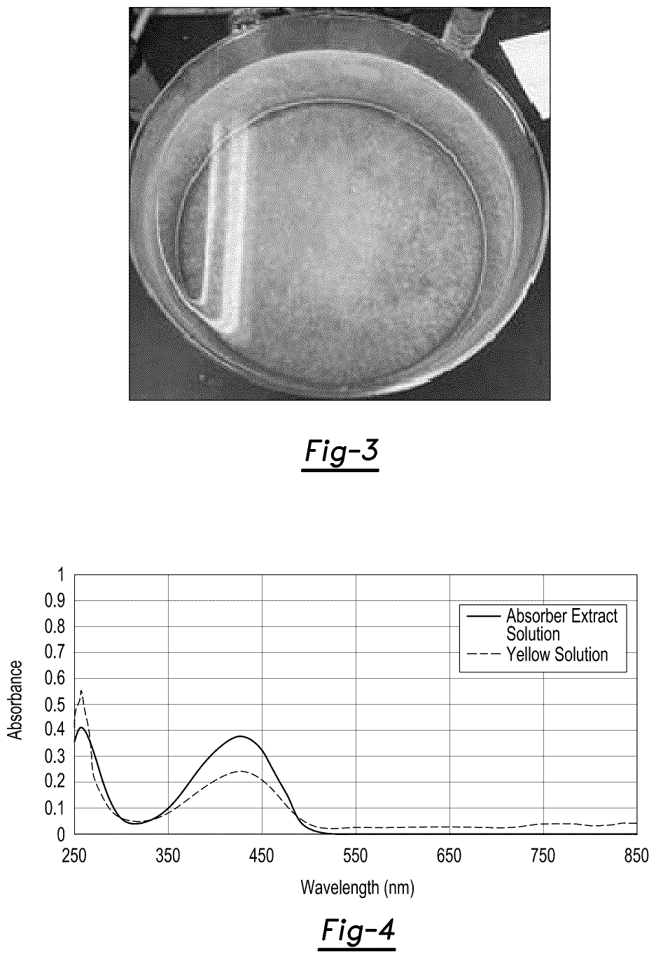

The contents of the cooled container included a solution of the extracted AY 23 dye, ethanol, and water, as well as the larger pieces of intact and/or degraded polymer from the shoe soles. The contents of the container were passed through a sieve to remove the larger pieces of degraded polymer, and then passed through a 2 μm fine filter to yield a yellow solution as shown in FIG. 3. The amount of AY 23 dye present in the yellow solution was less than 1 wt %.

After filtration, the yellow solution was concentrated by placing the yellow solution, which had been placed into another container, into the oven at a temperature of 100° C. until the total volume of the yellow solution was reduced to about 40 mL. The concentrated yellow solution included about 2 wt % of the extracted dye. It is believed that the extract may include up to 5 wt % of the extracted dye. The concentrated yellow solution was then combined with 0.75 wt % of TERGITOL® 15-S-19 as a surfactant and 15 wt % polypropylene glycol as a co-solvent to form an absorber extract solution.

To confirm that the AY 23 dye was extracted from the pieces of the shoe soles, the UV-vis absorbance spectra of the yellow solution (before being concentrated) and the absorber extract solution were obtained, and the respective spectra were overlaid on the graph shown in FIG. 4. The graph shows the same prominent absorption peak at a wavelength of 425 nm, indicating the presence of the extracted AY 23 dye in both the yellow solution and the absorber extract solution.

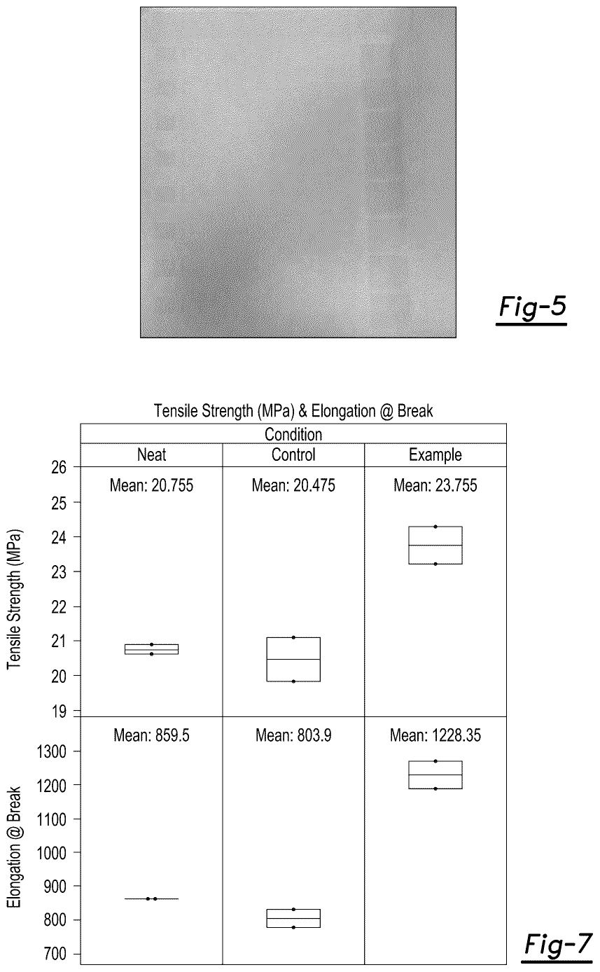

The absorber extract solution was printed on plain paper using a 2D inkjet printer to generate a 2D test print. A photograph of the 2D test print is shown in FIG. 5. The test print indicated that the absorber extract solution exhibited good jettability and exhibited a yellow color.

The absorber extract solution was also tested for decap performance. The term “decap performance,” as referred to herein, means the ability of the absorber extract solution to readily eject from a thermal inkjet printhead, upon prolonged exposure to air. The decap time is measured as the amount of time that a printhead may be left uncapped (i.e., exposed to air) before the printer nozzles no longer fire properly, potentially because of clogging from the drop forming region of the nozzle/firing chamber. To test the decap performance, a reference line of the absorber extract solution was printed from a printhead that was not uncapped (i.e., was not exposed to air). Then, the printhead was filled with the absorber extract solution and left uncapped (i.e., exposed to air) for 9 seconds before the absorber extract solution was ejected again from the printhead. While the results are not reproduced

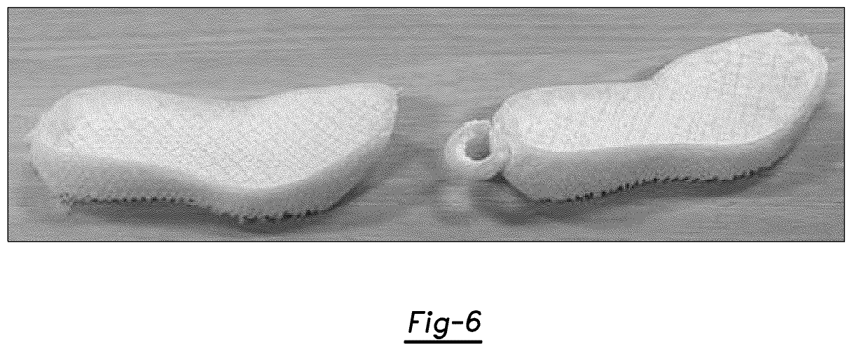

The absorber extract solution was also used as a second-generation fusing agent in a layer-by-layer 3D printing process described herein. The build material was a thermoplastic polyamide. Miniature midsole keychains were successfully printed using these materials on a testbed 3D printer employing a UV-LED radiation source. The 3D printed shoe sole keychains are shown in FIG. 6. As depicted, these keychains exhibited a yellow color due to the presence of the extracted AY 23 dye in the absorber extract solution. The keychains were handleable, indicating that the extracted AY 23 dye functioned as an efficient energy absorber.

A dye based first-generation fusing agent with the formulation set forth in Table 3 was also prepared.

TABLE 3

| Component | % active | Wt % |
|---|---|---|
| Urea | 100 | 1-20 |
| Benzyl alcohol | 100 | 1-20 |
| Propylene Glycol | 10 | 32 |
| AY 23 solution | 10 | 1-5 |
| TERGITOL ® 15-S-9 | 100 | 0.75 |
| KOLLIPHER ® RH40 | 100 | 1-3 |
| Deionized water | 100 | Balance |

3D objects were printed on a production-scale Multi-Jet Fusion (MJF) 3D printer. Thermoplastic polyamide copolymer powder was used as the build material. The first-generation fusing agent set forth in Table 3 was used to print some example objects, and a carbon black based fusing agent was used to print some control objects.

The example and control 3D objects were respectively cut down to size so that they could be processed on an injection molder. Neat (unused) thermoplastic polyamide copolymer powder was also injection molded for comparison. Two type V dogbanes were produced from each set of 3D parts in addition to a set of dogbanes produced from neat, unused powder. All three sets (Neat Objects 1 and 2, Control Objects 3 and 4, Example Objects 5 and 6) were subject to tensile testing on an Instron tensiometer and the results are shown in Table 4 and in FIG. 7.

TABLE 4

| Injection Molded | Tensile | Elongation |
|---|---|---|
| 3D Object | Strength (MPa) | @ Break |
| Neat 1 | 20.88 | 861.55 |
| Neat 2 | 20.63 | 857.45 |
| Control 3 | 21.11 | 829.55 |
| Control 4 | 19.84 | 778.25 |
| Example 5 | 23.2 | 1186.4 |
| Example 6 | 24.31 | 1270.3 |

It was unexpectedly found that the example injected molded objects exhibited properties that actually exceed those exhibited by the injected molded objects made from neat thermoplastic polyamide copolymer powder.

### Additional Notes

It is to be understood that the ranges provided herein include the stated range and any value or sub-range within the stated range. For example, from about 10 wt % active to about 50 wt % active should be interpreted to include not only the explicitly recited limits of from about 10 wt % active to about 50 wt % active, but also to include individual values, such as about 11 wt % active, about 22.5 wt % active, about 34 wt % active, about 48 wt % active, etc., and sub-ranges, such as from about 15 wt % active to about 45 wt % active, from about 20 wt % active to about 50 wt % active, from about 35 wt % active to about 40 wt % active, etc.

Furthermore, when “about” is utilized to describe a value, this is meant to encompass minor variations (up to +/−10%) from the stated value.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. A fusing agent comprising:
from about 10 wt % active to about 50 wt % active of a plasticizing solvent;
from about 30 wt % active to about 50 wt % active of a water miscible co-solvent; and
from about 10 wt % and about 30 wt % of an absorber extract solution,
wherein each wt % is based on a total weight of the fusing agent.

2. The fusing agent as defined in claim 1, wherein the absorber extract solution includes:
from about 0.01 wt % to about 3 wt % of an extracted dye, based on a total weight of the absorber extract solution;
from about 0.01 wt % to about 10 wt % of propylene glycol or oligomers thereof (up to N=4), ethylene glycol or oligomers thereof (up to N=4), or 1-(2-hydroxyethyl)-2-pyrrolidone (HE2P), based on the total weight of the absorber extract solution; and
a balance of water.

3. The fusing agent as defined in claim 2, wherein the extracted dye is a visible-light absorbing dye selected from the group consisting of Direct Black (DB) 168, Acid Yellow (AY) 23, AY 17, Acid Red (AR) 52, AR 289, Reactive Red 180 (RR 180), Direct Blue (DB) 199, and combinations thereof.

4. The fusing agent as defined in claim 2, wherein the extracted dye is an ultraviolet-light absorbing dye selected from the group consisting of pyranine, a pyranine derivative, coumarin, a coumarin derivative, a naphthalimide, a naphthalimide derivative, a disazomethine derivative, aldazine, and mixtures thereof.

5. The fusing agent as defined in claim 4, wherein the extracted dye is selected from the group consisting of solvent green 7, acid yellow 184, Acid Yellow 250, Yellow 101, Basic Yellow 40, Solvent Yellow 43, Solvent Yellow 44, Solvent Yellow 85, Solvent Yellow 145, Solvent Yellow 160:1, and combinations thereof.

6. The fusing agent as defined in claim 1, wherein the absorber extract solution includes:
from about 0.01 wt % to about 3 wt % of a colorless ultraviolet-light absorber, based on a total weight of the absorber extract solution;
from about 0.01 wt % to about 10 wt % of propylene glycol or oligomers thereof (up to N=4), ethylene glycol or oligomers thereof (up to N=4), or 1-(2-hydroxyethyl)-2-pyrrolidone (HE2P), based on the total weight of the absorber extract solution; and
a balance of water.

7. The fusing agent as defined in claim 1, wherein the colorless ultraviolet-light absorber is selected from the group consisting of benzotriazolyl dodecyl p-cresol, avobenzone, and diethylamino hydroxybenzoyl hexyl benzoate.

8. The fusing agent as defined in claim 1, further comprising a surfactant.

9. The fusing agent as defined in claim 1, further comprising from about 1 wt % active to about 3 wt % active of a solubilizing agent, based on the total weight of the fusing agent.

10. A three-dimensional printing kit, comprising:
a fusing agent including:
from about 10 wt % active to about 50 wt % active of a plasticizing solvent;
from about 30 wt % active to about 50 wt % active of a water miscible co-solvent; and
from about 10 wt % and about 30 wt % of an absorber extract solution,
wherein each wt % is based on a total weight of the fusing agent; and
a polymeric build material composition including a thermoplastic polyamide.

11. The three-dimensional printing kit as defined in claim 10, wherein the absorber extract solution includes from about 15 wt % to about 20 wt % of propylene glycol and from about 80 wt % to about 85 wt % of a radiation absorber extract, wherein each wt % is based on a total weight of the absorber extract solution.

12. The three-dimensional printing kit as defined in claim 11, wherein the absorber extract solution includes:
from about 0.01 wt % to about 3 wt % of an extracted dye, based on a total weight of the absorber extract solution; and
a balance of water.

13. The three-dimensional printing kit as defined in claim 12, wherein:
the extracted dye is a visible-light absorbing dye selected from the group consisting of Direct Black (DB) 168, Acid Yellow (AY) 23, AY 17, Acid Red (AR) 52, AR 289, Reactive Red 180 (RR 180), Direct Blue (DB) 199, and combinations thereof; or
the extracted dye is an ultraviolet-light absorbing dye selected from the group consisting of solvent green 7, acid yellow 184, Acid Yellow 250, Yellow 101, Basic Yellow 40, Solvent Yellow 43, Solvent Yellow 44, Solvent Yellow 85, Solvent Yellow 145, Solvent Yellow 160:1, and combinations thereof.

14. The three-dimensional printing kit as defined in claim 11, wherein the absorber extract solution includes:
from about 0.01 wt % to about 10 wt % of a colorless ultraviolet-light absorber selected from the group consisting of benzotriazolyl dodecyl p-cresol, avobenzone, and diethylamino hydroxybenzoyl hexyl benzoate, wherein the wt % is based on a total weight of the absorber extract solution; and
a balance of water.

15. A method, comprising:
dividing a thermoplastic polyamide 3D printed object into smaller pieces;
exposing the smaller pieces to an aqueous solution including from about 10 wt % active to about 80 wt % active of ethanol for a predetermined period of time, thereby extracting a radiation absorbing dye or a colorless ultraviolet light absorber from the thermoplastic polyamide 3D printed object;
generating an absorber extract solution from the extracted radiation absorbing dye or colorless ultraviolet-light absorber; and
formulating a second-generation fusing agent from the absorber extract solution.
